(19) United States
(12) Patent Application Publication
(10) Pub. No.: US 2012/0312400 A1
(43) Pub. Date: Dec. 13, 2012

(54) HIGH VOLUME WATER DELIVERY SYSTEM AND METHOD

(75) Inventor: David J. Elliot, Dawson Creek (CA)

(73) Assignee: FLO-DYNAMICS SYSTEMS, INC., Dawson Creek (CA)

(21) Appl. No.: 13/168,717

(22) Filed: Jun. 24, 2011

(30) Foreign Application Priority Data
Jun. 10, 2011 (CA) 2,743,054

(51) Int. Cl. B67D 7/70

(52) U.S. Cl. 137/565.29

(57) ABSTRACT

A system for delivering water is provided, including: a structure placeable within a water tank, the structure defining at least first and second compartments, the compartments separated by a baffle; and a bottom panel, said bottom panel having padding between the panel and a floor of the tank; first and second pumps, each of the first and second pumps placeable within the respective first and second compartments; the first and second pumps in fluid communication with a first end of respective first and second water transportation systems; and the first and second water transportation systems each having a second end, the second ends in fluid communication to a manifold.

### RELATED APPLICATIONS

The present application claims the benefit of priority based on copending Canadian Patent Application Serial No. ______, filed Jun. 10, 2011, in the name of inventor David J. Elliot, entitled “High Volume Water Delivery System and Method”, which is hereby incorporated by reference.

### FIELD OF THE INVENTION

This invention relates to systems and methods for delivery of high volumes of water, and more particularly to systems for delivering water from tanks to shale gas wells.

### BACKGROUND

In shale gas wells, water is used to carry a propping agent, such as sand, under pressure into a wellbore. The pressure causes the rock to ‘fracture’, and release the trapped gas. These fractures are held open by the propping agent. The water for this purpose is stored in lined open top tanks and is extracted from the tank at high volumes, at up to 18 m³/min. The open top tank should be leak proof, which is accomplished through the use of geomembrane liners. If the liner becomes damaged, the tank becomes at risk of developing a leak. The liner is typically either a one piece liner that is positioned inside the tank, covering the floor and the walls of the tank, or is several rolls of liner that are welded together to form a seal. The liner covers the floor and walls of the tank to form a watertight layer, independent of the tank structure.

Prior art pumping methods from lined open top tanks include:
a suction intake positioned at the bottom of the tank (usually at a bell hole), which is then piped under the wall of the tank and exits at the surface at the exterior of the tank wall, with a hole being cut in the liner; the intake extrusion is welded to the liner with a gasket;
a suction intake running through the wall of the tank, wherein a hole is cut in the liner and the tank wall, and the hole and piping are patch welded to create a seal;
a suction pipe that runs up over the wall of the tank, without penetrating it; wherein the water is “sucked” through the pipe by a centrifugal pump located outside the tank; and
an extremely heavy pumping structure placed directly onto the geomembrane liner on the tank floor.

For example a common pump solution is to use suction piping through the wall or floor of the tank, feeding centrifugal pumps. This system is undesirable because it involves cutting a hole in the leak-proof layer, and then re-sealing it. Also, the pumps are less robust than submersible pumps, and there is often no redundancy in case of pump failure which puts the water transfer at risk (and the well completion).

Another system currently available uses a single 10″ suction pipe that extends up alongside the wall of the tank and feeds a centrifugal pump(s). This system provides little redundancy and is extremely risky if a pump or power failure occurs. Also, output from centrifugal pump may not be consistent depending on the depth of water in the tank.

Yet another pump solution uses submersible pumps and is built out of an extremely heavy stair system. This system includes built in stairs that run over the wall of the tank. In this solution a number of submersible pumps are used that cavitate when in use as the pump intakes compete for available water. The bulk of the weight of the stairs is placed on the liner at the floor of the tank. The problem with this is that the pumps put a great deal of stress and pressure on the liner. The system is also extremely large, and not portable, requiring special trailers for highway transportation and large cranes for positioning. The size also posed a safety risk for workers potentially falling into the tank.

The problem with the prior art methods is that the geomembrane liner integrity is compromised, and the tank is therefore at risk of leaking Also, the pump systems used often do not meet the flow rates required.

### SUMMARY OF THE INVENTION

The system according to the invention is lightweight, highly portable, installable in a short amount of time, protects the tank liner, provides high flow rates, and has built in pump redundancy. The system includes a pump support having submersible pumps, and parallel piping over the wall of the tank that connects to a single manifold on the ground at the exterior of the tank. The only contact with the tank and liner is on the floor of the tank, and the contact area is sufficiently padded to provide a pressure footprint on the liner floor with a significant factor of safety within the geomembrane tensile specifications; and also provides tear and puncture resistance.

The system according to the invention supports the hydraulic stimulation (fracture) of shale gas wells. Water is stored in polyethylene geomembrane lined open top tanks, such as a C-RING (made by Westeel Storage Solutions). The invention provides a pump solution that pumps water from the tank to the frac water tanks at high volume, while maintaining the integrity of the geomembrane.

The system according to the invention is highly portable and can be installed quickly, and can provide a large water flow rate reaching and exceeding the frac pump down rates. This means that the user can be confident of their water delivery, and can focus on the frac process without worrying about water supplies. Also, the system provides pump redundancy for further risk reduction (minimum 30% redundancy). Finally, the system minimizes impact on the tank liner.

A system for delivering water is provided, including: a structure placeable within a water tank, the structure defining at least first and second compartments, the compartments separated by a baffle; and a bottom panel, said bottom panel having padding between the panel and a floor of the tank; first and second pumps, each of the first and second pumps placeable within the respective first and second compartments; the first and second pumps in fluid communication with a first end of respective first and second water transportation systems; and the first and second water transportation systems each having second ends, the second ends both in fluid communication to a manifold.

The first and second water communication systems may include first and second pipes extending above a wall of the tank and first and second hoses extending from an end of the respective first and second pipes to the manifold.

The system may include a third compartment, and a third pump in fluid communication with a third water communication system, the third water communication system having a third pipe and a third hose, the third hose in fluid communication with the manifold.

The system may include an elevated horizontal bar placeable to support the first, second and third pipes. The manifold may have an outlet for expelling water received through the first, second and third hoses.

### DESCRIPTION OF THE FIGURES

FIG. 1 is a perspective view of a system according to the invention;

FIG. 2 is a front view thereof from inside the tank;

FIG. 3 is a top view thereof; and

FIG. 4 is a side view thereof.

### DESCRIPTION OF THE INVENTION

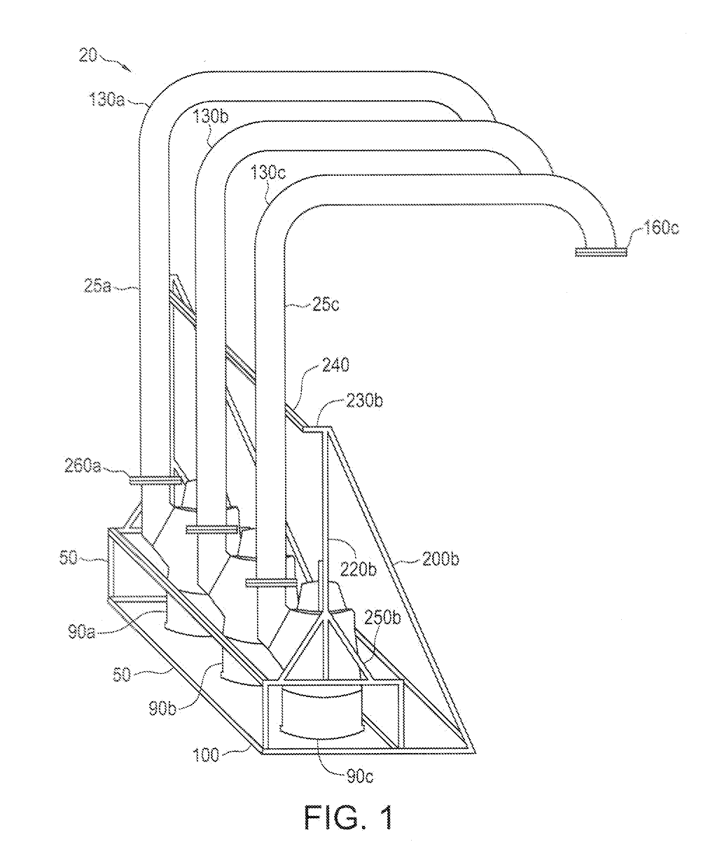

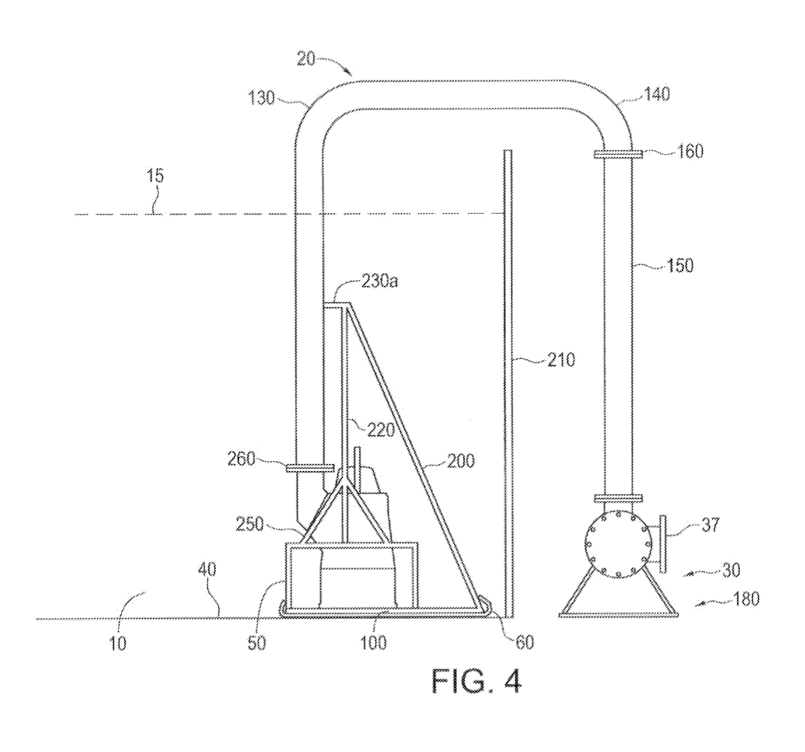

As shown in FIGS. 1 through 4, a water transportation system, such as discharge piping 20 leads from tank 10 to manifold 30. On the liner of floor 40 of tank 10, is pump support structure 50. As shown in FIG. 4, tank 10 is full to water line 15, although tank 10 may be empty or be filled to a different water level.

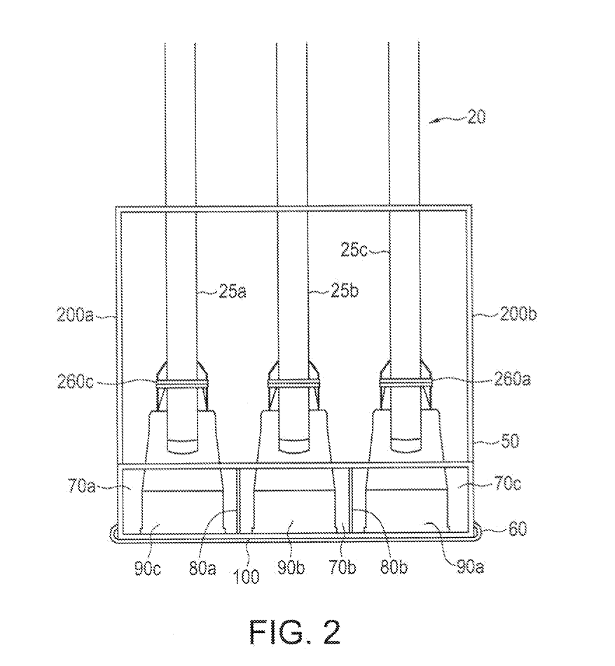

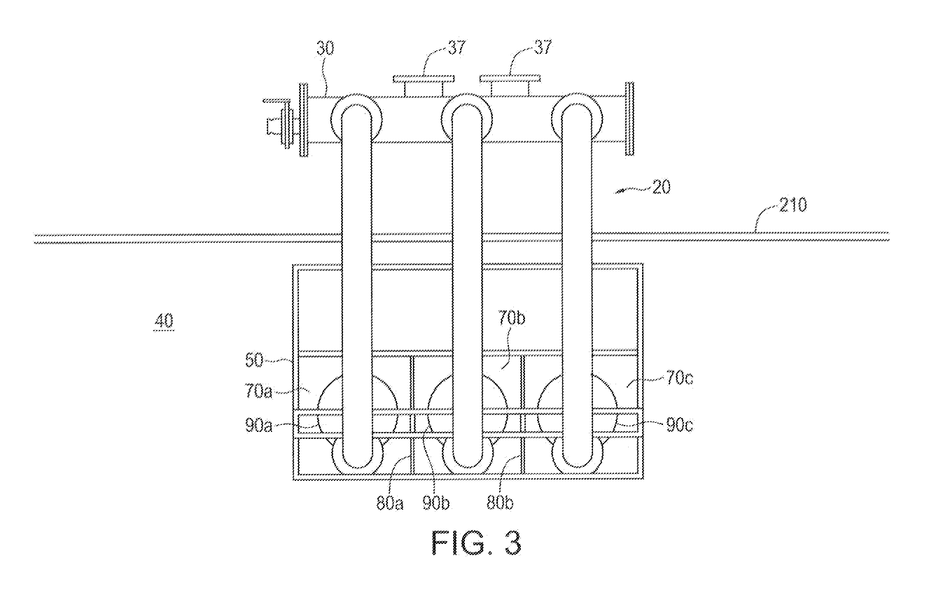

As shown in FIGS. 2 and 3, pump support structure 50 includes a plurality of compartments 70a, 70b, and 70c. Each compartment is defined within pump support structure 50 by one or both of dividing baffles, or walls 80a and 80b. Submersible water pumps 90a, 90b, and 90c are positioned in compartments 70a, 70b and 70c, respectively. In alternative embodiments of the invention, additional pumps may be present within additional compartments or only two compartments may be present.

Water enters pumps 90 from the bottom of pool 10. Base 100 of pump support structure 50 is flat, and rests on floor 40 on a foam padded layer 60, about one inch thick. Padded layer 60 is positioned between structure 50 and the biomembrane layer on the floor 40 of tank 10. Pumps 70 may be large, for example about 650 lbs each, and are designed for a high volume, such as 500 m3/hr, and with a head of over 40 m.

Base 100 may be a flat steel plate and should provide for a safety factor of at least two compared to the yield strength of the liner material, as listed in the product engineering data from the supplier. The perimeter of the tank wall in (inches) may equal=2×yield strength (in psi)/weight of structure including the pumps 90 (in pounds).

Stabilizer bars 200a, 200b each extend upwardly at about a 30 to 70 degree angle from the corners of base 100 closest to tank wall 210 towards compartments 80. Stabilizer bars 200a, 200b meet vertical bars 220a, 220b, respectively, at horizontal bars 230a, 230b. The two horizontal bars 230a, 230b are connected by support bar 240, which is sized to rest against and support piping 20. Vertical bars 220a, 220b, extend upwardly from the top of support structure 50, and may be supported by a plurality of short bars 250. Other arrangements of bars to add support to piping 20 may be substituted. Support structure 50 may be made of concrete, although bars 200, 220, 230, 240, and 250 may be made of concrete or a metal such as steel. . . .

Discharge piping 20 is steel piping sized to match the discharge diameter of pumps 90a, 90b and 90c, and is hard mounted to pump support structure 50. Discharge piping 20 includes a pipes 25a, 25b, and 25c, for each pump 90a, 90b, and 90c. Pipes 25a, 25b, 25c are directly coupled to pumps 90a, 90b, 90c via flanges 260a, 260b, 260c (which may each include a first flange on the pump 90 outlet, a second flange on the pipe 25, and a gasket between the flanges, maintained together by bolts. The piping 20 extends vertically above the height of the tank wall 210. First elbow joints 130a, 130b, 130c turn pipes 25 in a horizontal direction and second elbow joints 140a, 140b and 140c turn pipes 25 downwardly. Rubber hoses 150a, 150b, and 150c, are connected to flanges 160a, 160b, 160c at the end of each pipe 25a, 25b and 25c, and run downwardly to manifold 30 positioned at the base 180 exterior of tank wall 210. The rubber hoses 150 may be 100 psi discharge type water hose.

Pipes 25 each have an air vacuum release valve (not shown) along the top portion of the pipe between first elbow joint 130 and second elbow joint 140. This valve serves to stop the siphoning effect when the pump is shutdown

The above discharge piping system is a representative water transportation system. Other combinations of piping and hoses may be used to transport the water from the plurality of pumps 70 to a single manifold 30.

Piping 20 and pump support structure 50 may be lifted and placed into tank 10 as one unit Support structure 50 is typically placed near tank wall 210, and manifold 30 is placed near tank wall 210 on the exterior of tank 10. The distance separating support structure 50 and manifold 30 should be about equal to the length of the horizontal section of piping 20.

Manifold 30 accepts the pump discharge from hoses 150a, 150b and 150c in parallel, and is connected to other discharge piping (not shown) so that water can be transferred away from tank 10 to its destination. Two outlets 37 from manifold 30 may be used to allow the correct volume of water to be delivered. For example, a single 10″ line is capable of max 10 m³/min, so a second outlet can be used to obtain a 20 m³/min rate.

The parallel pump system according to the invention allows for flow variability, and pumps 90 can be isolated or added quickly and easily.

The system according to the invention is implemented by placing submersible pumps within support structure 50 and securing them at flange 260 to piping 20 inside of tank 10, and discharging the water up and over the wall 210 of the tank 10 into manifold 30. Contact with the watertight liner is minimized, and any contact between the support structure 50 and the liner is protected to prevent liner damage occurring.

The above-described embodiments have been provided as examples, for clarity in understanding the invention. A person with skill in the art will recognize that alterations, modifications and variations may be effected to the embodiments described above while remaining within the scope of the invention as defined by claims appended hereto.

I claim:

1. A system for delivering water, comprising:
a. a structure placeable within a water tank, the structure defining at least first and second compartments, said compartments separated by a baffle; and a bottom panel, said bottom panel having padding between said panel and a floor of said tank;
b. first and second pumps, each of said first and second pumps placeable within said respective first and second compartments;
c. said first and second pumps in fluid communication with a first end of respective first and second water transportation systems; and
d. said first and second water transportation systems each having a second end, said second ends in fluid communication to a manifold.

2. The system of claim 1 wherein said first and second water communication systems comprises first and second pipes extending above a wall of said tank, and first and second hoses extending from an end of said respective first and second pipes to said manifold.

3. The system of claim 2, further comprising a third compartment, and a third pump in fluid communication with a third water communication system, the third water communication system having a third pipe and a third hose, said third hose in fluid communication to said manifold.

4. The system of claim 3 wherein said structure further comprises an elevated horizontal bar placeable to support said first, second and third pipes.

5. The system of claim 4 wherein said manifold has and outlet for expelling water received through said first, second and third hoses.
